(19) United States
(12) Patent Application Publication
(10) Pub. No.: US 2012/0235439 A1
(43) Pub. Date: Sep. 20, 2012

(54) RETRACTABLE RACK AND CANOPY SYSTEM

(76) Inventor: Stanislaw Wojciech Mazur, Harwood Heights, IL (US)

(21) Appl. No.: 13/048,838

(22) Filed: Mar. 15, 2011

(51) Int. Cl. B60P 7/04; B60J 5/14; B60P 7/02

(52) U.S. Cl. 296/100.03; 296/100.01; 296/100.12

(57) ABSTRACT

The Retractable Rack & Canopy System may comprise a soft top version or a hard top version (or combination thereof). A retractable and extendable fabric covered canopy (soft top version) may be used in conjunction with a truck box for protecting transported cargo on a pick-up truck or with a flat bed trailer. Furthermore, the hard top version of the invention may comprise a plurality of nestable telescopic sections which may be retracted to a user-preferred position providing ready access to the cargo bed.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### FIELD OF THE INVENTION

The present invention relates generally to the field of vehicle-mountable canopies and more specifically relates to a retractable rack and canopy system for use with vehicles.

### DESCRIPTION OF THE RELATED ART

Vehicles are often used in modern societies to transport individuals or cargo between locations. Many individuals own pick-up trucks for the convenience of hauling loads in the cargo box. A pickup cargo box is typically constructed with box sides, a floor, a front and a tailgate, but without a top so that cargo may be efficiently transported within. The current design of pickup truck utility boxes provides convenience for many different tasks that users might have. Items of varying sizes may be transported since the box doesn't comprise an upper constraining means. Problems do however exist with the current pickup cargo box design in that the truck bed is open to the elements which can be damaging to many types of cargo. In addition, items being transported are not protected against vandalism or theft if the vehicle is left unattended.

“Camper shells” may be used as a solution to the above-mentioned problem(s). These shells are traditionally a rigid canopy and may be designed as a light-weight box-enclosing means to haul some small to medium sized cargos while securing the cargo against theft. When taller cargos are being transported, the camper shell must be removed, normally employing the aid of three or four people. Due to the inconvenience in removing and re-installing camper shells, an owner's camper shell will either take up considerable space being stored for long periods of time, or will be installed on the truck for long duration, even when not in use. The housing is usually made of fiberglass or aluminum, and is mounted atop the pickup truck's rear bed. The shell generally covers the entirety of the pickup truck bed; however the shell may be restrictive in nature as presently designed.

Tonneau covers are an option that may be used by owners of utility vehicles and trucks to cover and secure items in the pickup bed and/or protect them from the elements, depending on the type of tonneau cover. These covers come in a variety of styles. The most common style is the roll up tonneau made from cloth or vinyl which uses a rib-like structure to support the fabric and keep it taut. A snap-based system is also used, but has become less common due to truck owners not wanting to install the snaps on their vehicle as they typically require drilling or use permanent adhesive. Roll up Tonneaus may be opened by rolling the cover up toward the cab of the truck. Fiberglass or hard plastic tonneau covers are also available, but often have a low profile. Additionally, these covers are usually heavy and require gas struts to assist in opening and closing. Generally, truck bed covers protect the bed and its contents from sun, rain, sleet, snow, hail, wind, leaves, and vermin; however they may not be user-friendly or easily adaptable to fit the required application.

Various attempts have been made to solve the above-mentioned problems such as those found in U.S. Pat. and Pub. Nos. 5,516,182; 4,789,196; 6,149,217; 4,795,206; 2007/0267887; and D407,062. This prior art is representative of canopies. None of the above inventions and patents, taken either singly or in combination, is seen to describe the invention as claimed.

Ideally, a retractable rack and canopy system should be user—friendly, convenient in use, adaptable and, yet operate reliably and be manufactured at a modest expense. Thus, a need exists for a reliable retractable rack and canopy system to provide convenience and efficiency of use for vehicle owners and to avoid the above-mentioned problems.

### BRIEF SUMMARY OF THE INVENTION

In view of the foregoing disadvantages inherent in the known canopy art, the present invention provides a novel retractable rack and canopy system. The general purpose of the present invention, which will be described subsequently in greater detail is to provide convenience and efficiency of use for vehicle owners.

Various embodiments of a retractable rack and canopy system are disclosed herein generally comprising: a track rail assembly having a right-side track rail and a left-side track rail; a nestable shell assembly comprising a plurality of nestable shell-sections; at least one fastener; and a plurality of couplers. Hard top and soft top versions may function to provide user-friendly retractable rack and canopy systems.

The right-side track rail may be removably mountable to a right side truck box side upper horizontal planar surface via the fasteners. In a similar fashion, the left-side track rail is removably mountable to a left side truck box side upper horizontal planar surface via fasteners. When mounted, the right-side track rail and the left-side track rail are in a substantially parallel relationship to each other along a common horizontal plane.

The nestable shell sections of the nestable shell assembly are ‘nestibly-oriented’ in relation to each other in a slidable relationship preferably perpendicular to the right and left-side track rails and are able to be slidably-moved along the tracks. When the nestable shell sections are nestibly oriented (compactly) within the nestable shell assembly they comprise a retracted canopy (proximate the truck cab.) The nestable shell sections are able to be telescopically moved in relation to each other via the couplers. The nestable shell sections when non-nestibly oriented extend from the nestable shell assembly to comprise an extended canopy to cover the bed of the box. The couplers allow movement of the nestable shell sections in relation to the right-side and the left-side track rails allowing the nestable shell sections to move in relation to each other allowing an individual user to effectively manipulate the retractable rack and canopy system between retracted and extended position(s) thereby providing a retractably-protected-enclosure for a cargo box. In this way, the user is able to transport goods in a protected enclosure such that the environmental conditions (i.e. rain, snow, and wind etc.) do not degrade the goods being transported.

Another embodiment (soft top version) of the present invention is described herein for the retractable rack and canopy system preferably comprising: a track rail assembly having a right-side track rail and a left-side track rail (as in the hard top version); a plurality of support arches; a plurality of slider blocks; fasteners; rack corner posts; a canvas covering; and optionally a rear rollup door having adjacently interlocked horizontal slats (also optional on the hard top embodiment.) Similar to the aforementioned version, the right-side track rail is removably mountable to a right side truck box side upper horizontal planar surface via fasteners. The left-side track rail is also removably mountable to a left side truck box side upper horizontal planar surface via fasteners wherein the right-side track rail and the left-side track rail are in a substantially parallel relationship to each other along a horizontal plane to promote ease of sliding.

In the soft top embodiment, the support arches are oriented vertically-parallel to each other in a slidable relationship perpendicular to the right-side and the left-side track rails, wherein the support arches may have a slider block rigidly (or otherwise) fastened to each end of the support arches. Slider blocks are designed to slide within the right-side and left-side track rails allowing the support arches to move in relation to each other allowing a user to manipulate the retractable rack and canopy system between retracted and extended positions. The canvas covering may comprise flexible fabric; semi-flexible fabric; or rigid fabric. The canvas covering may comprise waterproof material and is preferably mounted accordion-style to the support arches such that the canvas covering is able to move with the support arches thereby facilitating retraction and extension of the retractable rack and canopy system providing a protected-enclosure for a cargo box.

A kit for manufacture and resale is disclosed herein including: the track rail assembly having right-side and said left-side track rails; support arches; slider blocks; fasteners; rack corner posts; rear rollup door having adjacently interlocked horizontal slats; canvas covering; and a set of user instructions. A kit for the hard top version is also available.

A method of use for the retractable rack and canopy system (hard top and soft top versions) is described comprising the steps of: unlocking the nestable shell assembly (or plurality of support arches in soft top version); retracting the rack and canopy system via telescoping inwardly the nestable shell-sections in relation to each other (or support arches and canvas covering); locking the nestable shell assembly (or plurality of support arches in soft top version) into a retracted position (to carry large items in the truck box above the plane of the box sides); unlocking the nestable shell assembly (or plurality of support arches in the soft top version); extending the rack and canopy system via telescoping outwardly the nestable shell-sections in relation to each other (or support arches and canvas covering); and locking the system in an extended position thereby providing a retractably-protected-enclosure for a cargo box. The method of use may further comprise the steps of opening/closing the rear roll-up door providing an enclosed truck bed box.

The present invention holds significant improvements and serves as a retractable rack and canopy system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, retractable rack and canopy system, constructed and operative according to the teachings of the present invention.

FIG. 1 shows a perspective view illustrating a retractable rack and canopy system in an extended position suitable for an in-use condition according to an embodiment of the present invention.

FIG. 2 is a perspective view illustrating the retractable rack and canopy system in a retracted position according to an embodiment of the present invention of FIG. 1.

FIG. 3A is a side perspective view illustrating the retractable rack and canopy system in a partially extended position according to an embodiment of the present invention of FIG. 1.

FIG. 3B is a rear perspective view illustrating the retractable rack and canopy system in an extended position according to an embodiment of the present invention of FIG. 1.

FIG. 4, shows the retractable rack and canopy system in an extended position with an exploded view of support arches supporting a canvas covering, the support arches coupled to track rails according to an embodiment of the present invention of FIGS. 2-3B.

FIG. 5 is a perspective view illustrating the retractable rack and canopy system in a retracted position according to a hard-top embodiment of the present invention of FIG. 1.

FIG. 6A is a side perspective view illustrating the retractable rack and canopy system in an extended position according to an embodiment of the present invention of FIGS. 1 and 5.

FIG. 6B is a rear perspective view illustrating the retractable rack and canopy system with a rear rollup door according to an embodiment of the present invention of FIGS. 1 and 6A.

The various embodiments of the present invention will hereinafter be described in conjunction with the appended drawings, wherein like designations denote like elements.

### DETAILED DESCRIPTION

As discussed above, embodiments of the present invention relate to a canopy device and more particularly to a retractable rack and canopy system as used to improve the convenience and efficiency of vehicle use by vehicle owners. Use of the present invention allows a user to make efficient use of the cargo carrying capabilities of a truck and/or trailer.

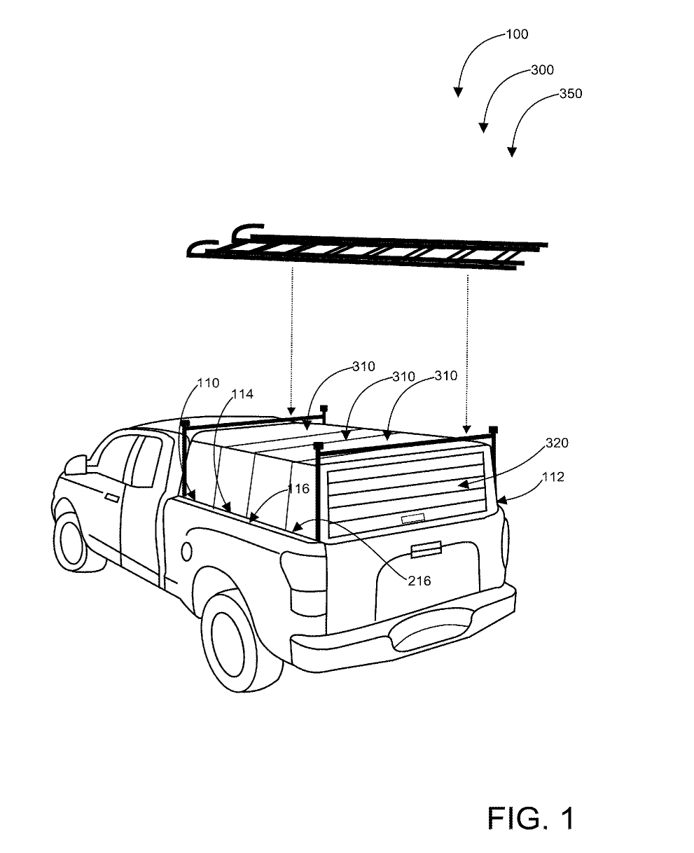

Referring now to the drawings by numerals of reference there is shown in FIG. 1, a perspective view illustrating a retractable rack and canopy system 100 in an extended position 350 suitable for an in-use condition according to an embodiment of the present invention. Retractable rack and canopy system 100 preferably comprising: a track rail assembly 110 having a right-side track rail 112 and a left-side track rail 114; a nestable shell assembly 300 comprising a plurality of nestable shell-sections 310; at least one fastener 216; and a plurality of couplers 130. Upon reading this specification, it should be appreciated that, under appropriate circumstances, considering such issues as user preferences, design preference, structural requirements, marketing preferences, cost, available materials, technological advances, etc., other coupling means such as, for example, wheels, sliders, magnets, fastener(s) 216, etc., may be sufficient.

Right-side track rail 112 is removably mountable to a right side truck box side upper horizontal planar surface 118 via at least one fastener(s) 216 and in a like manner; left-side track rail 114 is removably mountable to a left side truck box side upper horizontal planar surface 116 via at least one fastener(s) 216. The right-side track rail 112 and left-side track rail 114 are preferably in a substantially parallel relationship to each other along a horizontal plane; wherein a plurality of nestable shell-sections 310 of the nestable shell assembly 300 are nestibly-oriented in relation to each other in a slidable relationship perpendicular to right-side track rail 112 and left-side track rail(s) 114. Right-side track rail 112 and left-side track rail(s) 114 are vertically stackable, as shown, in certain embodiments.

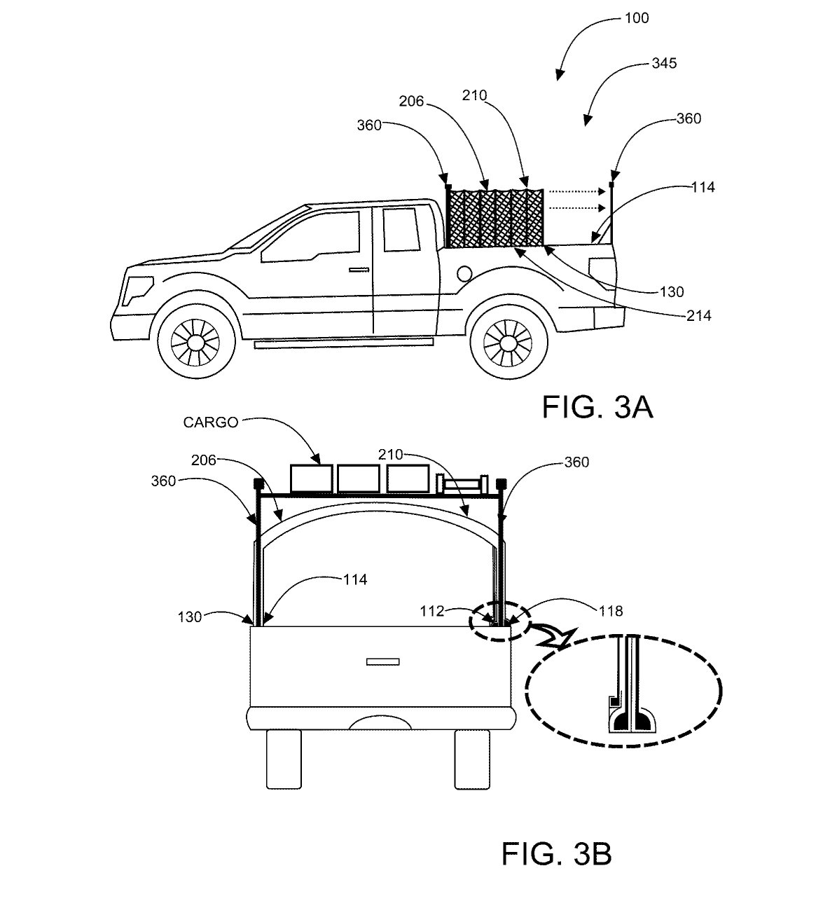

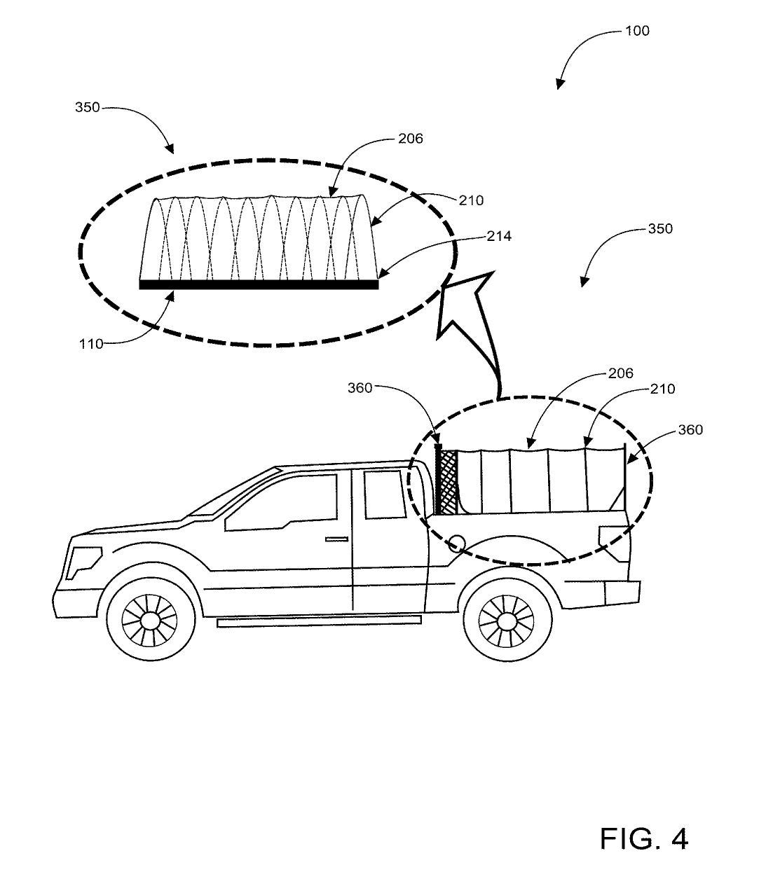

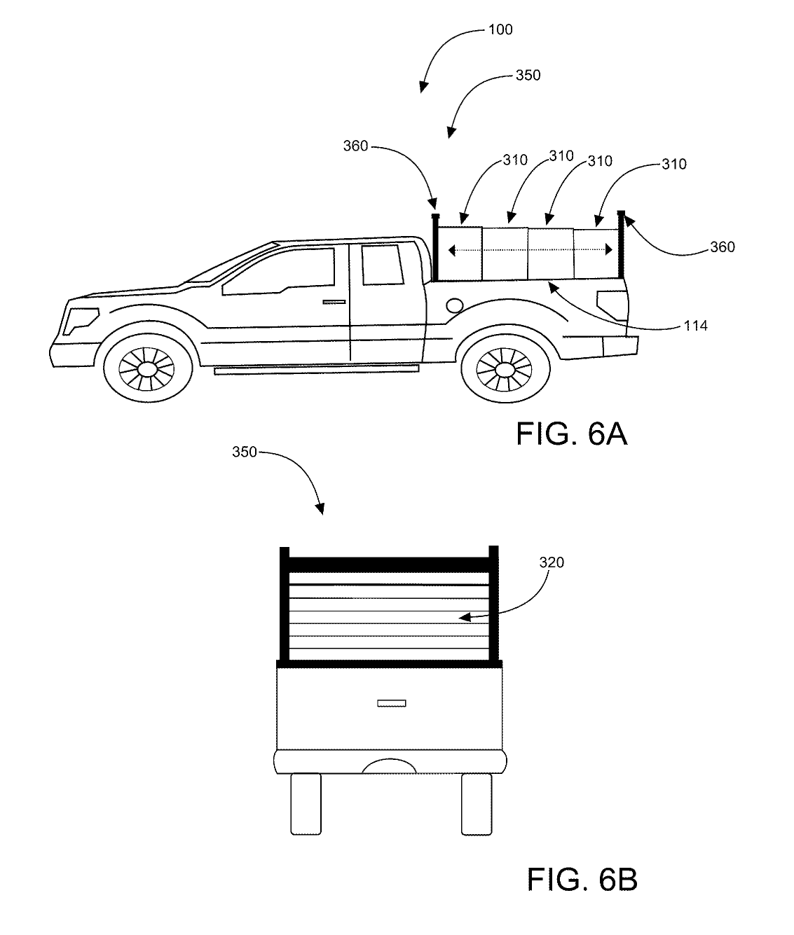

When the nestable shell-sections 310 are ‘nestibly oriented’ within the nestable shell assembly 300, the position comprises a retracted canopy. When the nestable shell-sections 310 are telescopically moved in relation to each other via couplers 130 and the nestable shell-sections 310 are non-nestibly oriented or extend from the nestable shell assembly 300, the position comprises an extended canopy (as shown in the present FIG. 1.) Couplers 130 allow movement of nestable shell-sections 310 in relation to the right-side track rail 112 and left-side track rail(s) 114 allowing nestable shell-sections 310 to move in relation to each other allowing a (single) user to manipulate the retractable rack and canopy system 100 between retracted position 340 and extended position 350, thereby providing a retractably-protected-enclosure for a cargo box. In this particular embodiment and those shown in FIGS. 4-6B retractable rack and canopy system 100 comprises a rigid construction. A ladder is also shown, that may be secured to racks such that nestable shell-sections 310 will not be damaged by carrying cargo, as the racks take the load, as also shown in FIG. 3B. Additionally, the racks may have a planar surface such as a sheet of plywood or other attached such that shorter cargo may be transported. Cargo may comprise large weights and short/long lengths. When noting the difference between FIGS. 3B and 6B it is shown that rear rollup door 320 may be left in position (shown in FIG. 6B) in (rear) rack corner posts 360 as a one-piece unit or removed (shown in FIG. 3B) as a two-piece unit leaving rack corner posts 360 in place without rear rollup door 320. In the preferred embodiment rear rollup door 320 may be left in place during in-use and non-use period and wind may pass through the slats (conforming as louvers.) In this way horizontal slats can act as louvers that may rotate to allow wind therethrough for example when traveling at highway speeds. This particular option may be available in either embodiment (soft and/or hard top.)

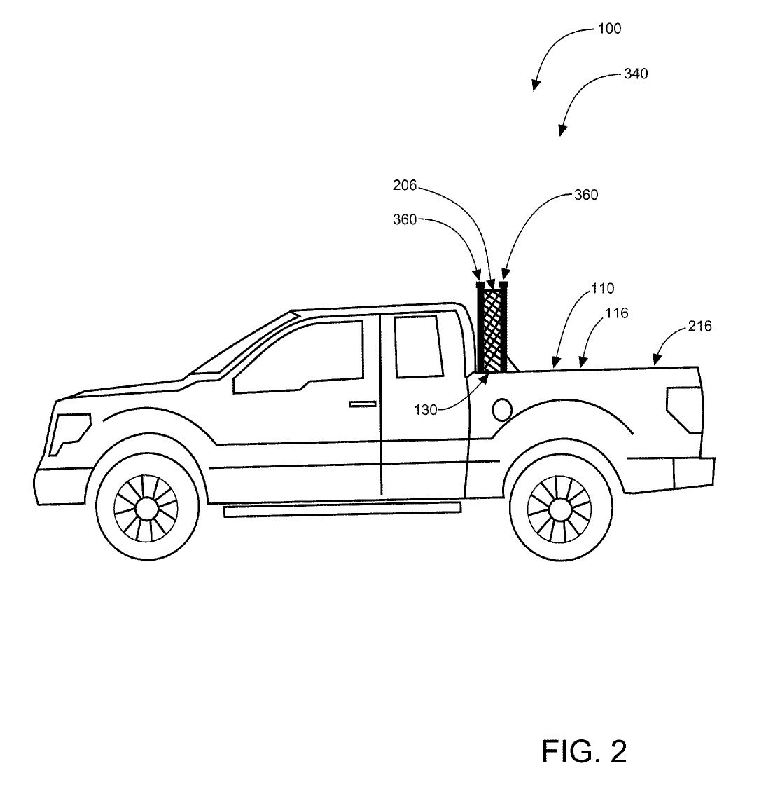

Referring now to FIG. 2 showing a perspective view illustrating retractable rack and canopy system 100 in a retracted position 340 according to an embodiment of the present invention of FIG. 1.

Another embodiment (soft top version) of retractable rack and canopy system 100 is shown in the present figure and in FIGS. 3A-4 preferably comprising: a track rail assembly 110 also having a right-side track rail 112 and a left-side track rail 114; a plurality of support arches 210; a plurality of slider blocks 214; at least one fastener 216; and a canvas covering 206. The right-side track rail 112 is removably mountable to a right side truck box side upper horizontal planar surface 118 via at least one fastener 216 and the left-side track rail 114 is removably mountable to a left side truck box side upper horizontal planar surface 116 via at least one fastener 216. Right-side track rail 112 and left-side track rail 114 are mounted in a substantially parallel relationship to each other along a horizontal plane, similar to the hard top embodiment.

The support arches 210 are preferably oriented vertically-parallel to each other in a slidable relationship (whereby the distance in between them may be increased or decreased), vertically perpendicularly related to the right-side track rail 112 and left-side track rail 114 with the support arches 210 having one slider block 214 preferably rigidly fastened to each end of the support arch(es) 210. The slider block(s) 214 slide within the right-side track rail 112 and left-side track rail 114 allowing each of the support arches 210 to move in relation to each other allowing a user to manipulate the retractable rack and canopy system 100 between a retracted position 340 and an extended position 350. The canvas covering 206 preferably mounts accordion-style to the plurality of support arches 210 such that the canvas covering 206 is able to (foldably) move with the support arches 210 facilitating retraction and extension of the retractable rack and canopy system 100 thereby providing a protected-enclosure for a cargo box.

Referring now to FIG. 3A showing a side perspective view illustrating retractable rack and canopy system 100 in a partially extended position 345 according to an embodiment of the present invention of FIG. 1. Canvas covering 206 of retractable rack and canopy system 100 in this embodiment may comprise a flexible fabric or may comprise a semi-flexible fabric. In other embodiments the amount of relative flexibility may change to suit the application. It should also be noted that the present invention is designed such that it may fit with truck beds of varying sizes, including short box, long box and other versions ranging from about 5½ to 8 feet. Other sizes, widths, lengths, heights may also be available and retractable rack and canopy system 100 may be fit accordingly (using overlap in nestable shell-section(s) 310 or placing support arches 210 at a closer/further distance from each other, etc.) In this way the present invention may be used on larger trucks and/or trailers, and/or SUVs (eg. Chevrolet Avalanche® and others—wherein the cab and box orientation may be different from traditional pick-up trucks.)

FIG. 3B shows a rear perspective view illustrating retractable rack and canopy system 100 in an extended position 350 according to an embodiment of the present invention of FIG. 1. Retractable rack and canopy system 100 canvas covering 206 comprises a rigid fabric preferably being made of at least one waterproof material. The retractable rack and canopy system 100 may further comprise rack corner posts 360 for securing the retractable rack and canopy system 100 in an extended position 350. Rack corner posts 360 provide mounting points to suitably stabilize retractable rack and canopy system 100. In certain embodiments the rear open portion may be covered via a tarpaulin with ties, clips, snaps, hooks or others (not shown.)

Referring now to FIG. 4, showing retractable rack and canopy system 100 in an extended position 350 with an exploded view of support arches 210 supporting canvas covering 206 with support arches 210 coupled to right-side track rail 112 and left-side track rail(s) 114.

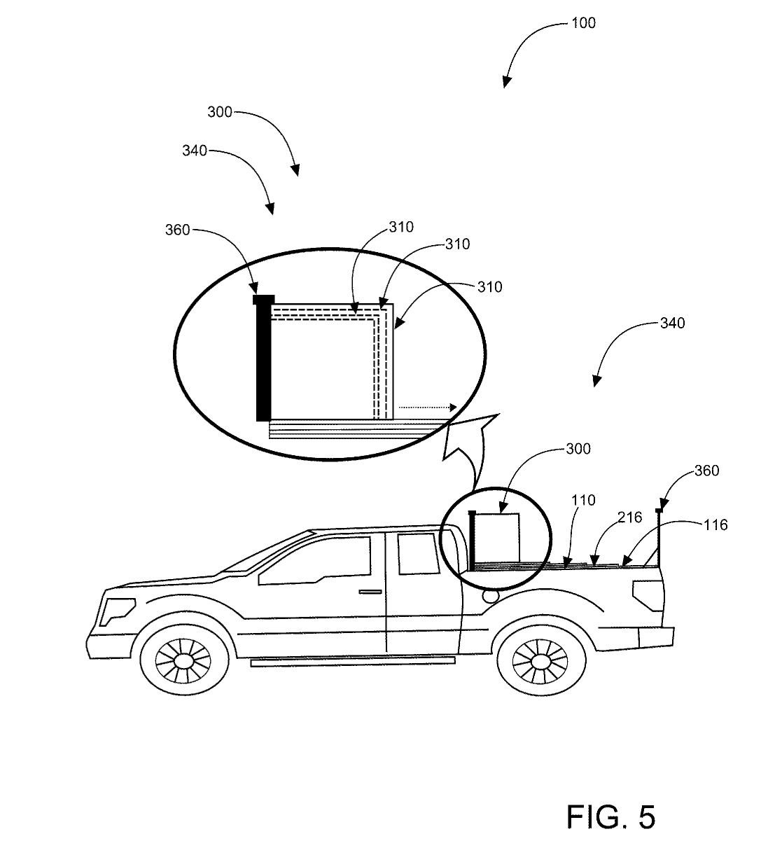

Referring now to FIG. 5, a perspective view illustrating retractable rack and canopy system 100 in retracted position 340 according to a hard-top embodiment of the present invention of FIG. 1.

Retractable rack and canopy system 100 in this particular embodiment comprises a rigid construction wherein nestable shell assembly 300 may comprise metal such as aluminum or other suitable material. Other embodiments of the rigid nestable shell-sections 310 may comprise a non-metal structure such as fiberglass.

FIG. 6A illustrates a side perspective view showing retractable rack and canopy system 100 in extended position 350 according to an embodiment of the present invention of FIG. 1. Nestable shell assembly 300 of retractable rack and canopy system 100 is lockable in the retracted position 340 and in the extended position 350 to provide security for the items that may be contained within the truck box. Each of the nestable shell-sections 310 of retractable rack and canopy system 100 may comprise seals affixed externally at the forward-most outer surface so as to create a substantially water tight seal between the forward-most outer surface of that nestable shell-section(s) 310 with the forward-most inner surface of the subsequent nestable shell-section(s) 310.

FIG. 6B is a rear perspective view illustrating retractable rack and canopy system 100 with rear rollup door 320 according to an embodiment of the present invention of FIGS. 1 and 6A. Retractable rack and canopy system 100 rear rollup door 320 preferably comprises horizontal slats that are adjacently interlocked. Rear rollup door 320 may be repeatedly moved between open and closed positions such that an individual may conveniently access items stored in the truck box. Rear rollup door 320 may also be lockably engaged with the tailgate to provide additional security and stability for retractable rack and canopy system 100.

A method of use for the retractable rack and canopy system 100 (hard top and soft top versions) preferably comprises the steps of: unlocking nestable shell assembly 300 (or plurality of support arches 210 in soft top version); retracting the retractable rack and canopy system 100 via telescoping inwardly moving the nestable shell-section(s) 310 in relation to each other (or support arches 210 and canvas covering 206); locking nestable shell assembly 300 (or plurality of support arches 210 in soft top version) into a retracted position 340 (to carry large items in the truck box). Nestable shell assembly 300 (or plurality of support arches 210 in soft top version) may be manipulated by extending retractable rack and canopy system 100 via telescoping outwardly the nestable shell-section(s) 310 in relation to each other (or support arches 210 and canvas covering 206); and locking the system in an extended position 350 thereby providing a retractably-protected-enclosure for a cargo box. The method of use may further comprise the steps of opening/closing the rear rollup door 320 providing an enclosed truck bed box for safe storage of transported items.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A retractable rack and canopy system comprising:
a track rail assembly having a right-side track rail and a left-side track rail;
a plurality of support arches;
a plurality of slider blocks;
at least one fastener; and
a canvas covering;
wherein said right-side track rail is removably mountable to a right side truck box side upper horizontal planar surface via said at least one fastener;
wherein said left-side track rail is removably mountable to a left side truck box side upper horizontal planar surface via said at least one fastener;
wherein said right-side track rail and said left-side track rail are in a substantially parallel relationship to each other along a common horizontal plane;
wherein said support arches are oriented vertically-parallel to each other in a slidable relationship perpendicular to said right-side and said left-side track rails;
wherein said support arches have one of said slider blocks rigidly fastened to each end of said support arch;
wherein said slider blocks slide within said right-side and said left-side track rails allowing said support arches to move in relation to each other allowing a user to manipulate said retractable rack and canopy system between retracted and extended positions; and
wherein said canvas covering mounts accordion-style to said plurality of support arches such that said canvas covering is able to move with said support arches thereby facilitating retraction and extension of said retractable rack and canopy system providing a protected-enclosure for a cargo box.

2. The retractable rack and canopy system of claim 1 wherein said canvas covering comprises flexible fabric.

3. The retractable rack and canopy system of claim 1 wherein said canvas covering comprises semi-flexible fabric.

4. The retractable rack and canopy system of claim 1 wherein said canvas covering comprises rigid fabric.

5. The retractable rack and canopy system of claim 1 wherein said canvas covering comprises waterproof material.

6. The retractable rack and canopy system of claim 1 further comprising rack corner posts.

7. The retractable rack and canopy system of claim 6 further comprising a rear rollup door wherein said rear rollup door is able to be left in said rack corner posts during a non-use condition.

8. The retractable rack and canopy system of claim 7 wherein said rear rollup door comprises horizontal slats that can act as louvers.

9. The retractable rack and canopy system of claim 8 wherein said horizontal slats are adjacently interlocked.

10. A retractable rack and canopy system comprising:
a track rail assembly having a right-side track rail and a left-side track rail;
a nestable shell assembly comprising a plurality of nestable shell-sections;
at least one fastener; and
a plurality of couplers;
wherein said right-side track rail is removably mountable to a right side truck box side upper horizontal planar surface via said at least one fastener;
wherein said left-side track rail is removably mountable to a left side truck box side upper horizontal planar surface via said at least one fastener;
wherein said right-side track rail and said left-side track rail are in a substantially parallel relationship to each other along a horizontal plane;
wherein said plurality of nestable shell sections of said nestable shell assembly are nestibly-oriented in relation to each other in a slidable relationship perpendicular to said right-side and said left-side track rails;
wherein said nestable shell sections when nestibly oriented within said nestable shell assembly comprise a retracted canopy;
wherein said nestable shell sections are able to be telescopically moved in relation to each other via said couplers;
wherein said nestable shell sections when non-nestibly oriented extend from said nestable shell assembly to comprise an extended canopy; and
wherein said couplers allow movement of said nestable shell sections in relation to said right-side and said left-side track rails allowing said nestable shell sections to move in relation to each other allowing a single user to manipulate said retractable rack and canopy system between retracted and extended positions thereby providing a retractably-protected-enclosure for a cargo box.

11. The retractable rack and canopy system of claim 10 wherein said nestable shell-sections comprise a rigid construction.

12. The retractable rack and canopy system of claim 11 wherein said rigid construction of said nestable shell-sections comprises metal.

13. The retractable rack and canopy system of claim 11 wherein said rigid construction of said nestable shell-sections comprises aluminum.

14. The retractable rack and canopy system of claim 11 wherein said rigid construction of said nestable shell-sections comprises fiberglass.

15. The retractable rack and canopy system of claim 11 wherein said nestable shell assembly comprises seals.

16. The retractable rack and canopy system of claim 10 further comprises a rear rollup door.

17. The retractable rack and canopy system of claim 10 further comprises rack corner posts.

18. The retractable rack and canopy system of claim 10 wherein said nestable shell assembly is lockable in said retracted and said extended positions.

19. A retractable rack and canopy system comprising:
a track rail assembly having a right-side track rail and a left-side track rail;
a plurality of support arches;
a plurality of slider blocks;
at least one fastener;
rack corner posts;
a rear rollup door having adjacently interlocked horizontal slats; and
a canvas covering;
wherein said right-side track rail is removably mountable to a right side truck box side upper horizontal planar surface via said at least one fastener;
wherein said left-side track rail is removably mountable to a left side truck box side upper horizontal planar surface via said at least one fastener;
wherein said right-side track rail and said left-side track rail are in a substantially parallel relationship to each other along a horizontal plane;
wherein said support arches are oriented vertically-parallel to each other in a slidable relationship perpendicular to said right-side and said left-side track rails;
wherein said support arches have one of said slider blocks rigidly fastened to each end of said support arch;
wherein said slider blocks slide within said right-side and said left-side track rails allowing said support arches to move in relation to each other allowing a user to manipulate said retractable rack and canopy system between retracted and extended positions;
wherein said canvas covering comprises flexible fabric or semi-flexible fabric;
wherein said canvas covering comprises waterproof material; and
wherein said canvas covering mounts accordion-style to said plurality of support arches such that said canvas covering is able to foldably move with said support arches thereby facilitating retraction and extension of said retractable rack and canopy system providing a protected-enclosure for a cargo box.

20. The retractable rack and canopy system of claim 19 further comprising a kit including:
said track rail assembly having said right-side track rail and said left-side track rail;
said plurality of support arches;
said plurality of slider blocks;
said fasteners;
said rack corner posts;
said rear rollup door having said adjacently interlocked horizontal slats;
said canvas covering; and
a set of user instructions.
